(19) United States
(12) Patent Application Publication
(10) Pub. No.: US 2002/0046064 A1
(43) Pub. Date: Apr. 18, 2002

(54) Method and system for furnishing an on-line quote for an insurance product

(76) Inventors: Hector Maury, Manchester, CT (US); Michael Saucier, Southington, CT (US); Ruth B. Grover, Marlborough, CT (US); Donald White, Amston, CT (US); Linda Hirning, Rocky Hill, CT (US)

Correspondence Address: KILPATRICK STOCKTON LLP, 607 14TH STREET, N.W., SUITE 900, WASHINGTON, DC, 20005, US

(21) Appl. No.: 09/860,679

(22) Filed: May 18, 2001

Related U.S. Application Data
(60) Provisional application No. 60/206,007, filed on May 19, 2000.

(51) Int. Cl. G06F 17/60

(52) U.S. Cl. 705/4

(57) ABSTRACT

A method and system for furnishing an on-line quote for an insurance product, such as auto insurance, makes use of computer hardware and software to provide a user with an on-line, real-time quote. The system allows the user to enter user information and recommends coverages, liabilities, and deductibles to help the user determine the best insurance coverage for the user's needs. Upon entering the user data and coverage information on a presentation server, deployable content profile information is retrieved by the presentation server, and a quote is displayed for the user. If the user indicates a continued interest in the quote, a client number is presented to the user and sent to a computer telephony integration database.

### PRIORITY APPLICATION

This application claims the benefit of U.S. Provisional Application No. 60/206,007 filed May 19, 2000, and entitled “Method and System for Furnishing an On-Line Quote for an Insurance Product (QuickQuote),” incorporated herein by this reference.

### CROSS REFERENCE TO RELATED APPLICATIONS

This application is related to U.S. Provisional Application filed simultaneously herewith on May 18, 2001, and entitled, “Method and System for Furnishing an On-Line Quote for an Insurance Product (QuickQuote),” incorporated herein by this reference.

### FIELD OF THE INVENTION

The present invention relates generally to the field of electronic commerce, and more particularly to a method and system for providing a user with an on-line, real-time quote for an insurance product, such as an auto insurance product.

### BACKGROUND OF THE INVENTION

Presently available on-line quoting tools for insurance products, such as auto insurance, do not allow a user to receive real-time advice. The current environment consists, for example, of Hypertext Markup Language (HTML) forms that allow a user to enter some of the information needed for the generation of auto quotes. That information is then emailed to a customer support representative (CSR) via a Common Gateway Interface (CGI) process. The CSR subsequently contacts the user to gather additional information and generate a quote, for example, via a legacy system. Thus, it is not possible for the user to receive real-time advice, such as the availability of different types of insurance products or the various coverage requirements of different states.

### SUMMARY OF THE INVENTION

It is a feature and advantage of the present invention to provide a method and system for furnishing an on-line quote to a user for an insurance product, such as auto insurance, which enables the quote to be presented in real time, without the delay inherent, for example, with the use of email.

It is another feature and advantage of the present invention to provide a method and system for furnishing a real-time, on-line quote to a user for an insurance product, such as auto insurance, which frees up CSR personnel resources to focus on the sale of policies and reduces costs in terms of CSR personnel.

It is a further feature and advantage of the present invention to provide a method and system for furnishing an on-line quote to a user for an insurance product, such as auto insurance, in which the upload of information collected by the system also reduces costs, for example, by eliminating the need for CSR personnel to retype the information into a host system for use in downstream systems.

It is an additional feature and advantage of the present invention to provide a method and system for furnishing an on-line quote to a user for an insurance product, such as auto insurance, in which data uploaded to a database is used for management information reporting.

To achieve the stated and other features, advantages and objects, the system and method for an embodiment of the present invention makes use of computer hardware and software to provide a user with an on-line, real-time quote for an insurance product, such as auto insurance. Thus, the system of the present invention allows the user to receive real-time advice, for example, about the different types of insurance products available, or the various coverage requirements of different states, with all of the convenience of an on-line agent. The system provides an on-line auto quoting application that includes a coverage wizard which provides state-specific on-line counseling to help make insurance decisions. Further, the system of the present invention provides a unique on-line quoting tool which enables the user to enter information, for example, about himself or herself, his or her income, his or her ability to live without a car, and other similar types of information about the user's lifestyle. The application for an embodiment of the present invention then recommends to the user coverages and liabilities, deductibles, and similar items to help the user determine the best insurance coverage to meet his or her needs.

In an embodiment of the present invention, a user is allowed to log on to a web site and access an on-line quote application on a presentation server via a link from the web site. The user is then allowed to enter user data and coverage information on the presentation server, and the presentation server retrieves deployable content profile information for the user from a database. The deployable content profile information, for example, allows the user to be identified by an underwriter and/or allows the user to be directed to a customer support representative or a selected agent. In an aspect of the deployable content profile information, a business user is allowed to access a deployable content administration tool page. The business user is authenticated with a username and password and is presented an administration tool screen pre-filled with data from existing files. In another aspect of the deployable content profile information, an administration tool output is written to a file and/or the database.

If the user enters a vehicle identification number, a database query is executed by the presentation server, and auto information corresponding to the vehicle identification number is retrieved for the user from a vehicle identification database by the presentation server. Otherwise, a vehicle identification number is constructed for the user by the presentation server utilizing user-entered make and model information in conjunction with the vehicle identification number database. The user is allowed to enter a request for the quote on the presentation server, and the user data is formatted and transferred to a rating engine server via a Java module. The user data is submitted to a knowledge-based management system module and database, which determine a tier corresponding to the user data and return the tier to the rating engine server. The rating engine server returns the requested quote to the presentation server, which displays the quote for the user, and a management information database is updated with the user data and the quote.

If an indication of continued interest in the requested quote is received from the user by the presentation server, the user is presented with a client number associated with the quote, and the quote data is sent to a computer telephony integration database. The process of presenting the client number involves, for example, transferring pre-fill data for the user to the rating engine server by the presentation server, transferring formatted user data to a host application via message queue series, generating the client number by the host application, and returning the client number by the host application through a message queue series return queue. The client number is displayed for the user by the presentation server for reference in communicating with a customer support representative. In addition, the client number is logged in a management information database and/or recorded in a quote database.

Additional objects, advantages, and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic diagram which illustrates an example overview of key components and the flow of information between key components for the online insurance quote system for an embodiment of the present invention;

FIG. 2 is a schematic diagram which provides further detail regarding key components and the flow of information between key components of the system for an embodiment of the present invention shown in FIG. 1;

FIG. 3 is a schematic diagram which illustrates an overview of key components and the flow of information between key components for an example of the rating engine utilized for the system for an embodiment of the present invention;

FIG. 4 is a chart which illustrates examples of data tables for the system of an embodiment of the present invention;

FIG. 5 is a block diagram which illustrates an example of a data transfer protocol visual model utilized for the system for an embodiment of the present invention;

FIG. 6 is a flow chart which illustrates an example of the process of generating a quote by the system for an embodiment of the present invention;

FIG. 7 is a flow chart which illustrates another example of the process of generating a quote by the system for an embodiment of the present invention;

FIG. 8 is a schematic diagram that illustrates an example of components of the deployable content functionality for an embodiment of the present invention; and

FIG. 9 is a flow chart which illustrates an example of the process flow of the deployable content administration tool application for an embodiment of the present invention.

### DETAILED DESCRIPTION

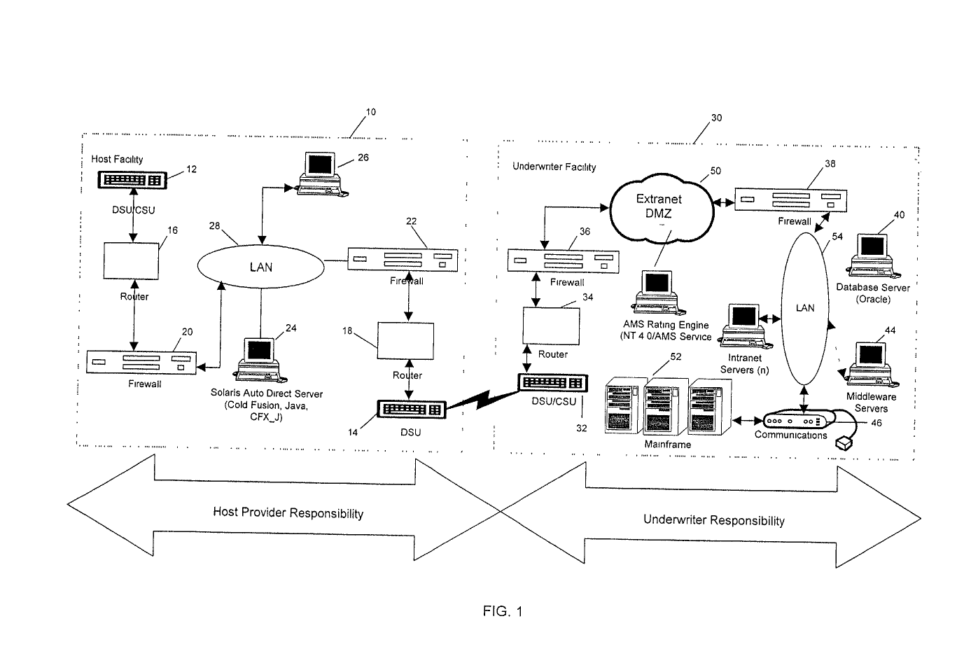

Referring now in detail to an embodiment of the present invention, an example of which is illustrated in the accompanying drawings, FIG. 1 is a schematic diagram which illustrates an example overview of key components and the flow of information between key components for the on-line insurance quote system for an embodiment of the present invention. Referring to FIG. 1, the system utilizes, for example, a host facility 10 with data service units/channel service units (DSUs) 12, 14, routers 16, 18, firewalls 20, 22, and servers 24, 26 connected over a local area network (LAN) 28. The system also makes use, for example, of an underwriter's facility 30 coupled to the host facility 10 with DSU 32, router 34, firewalls 36, 38, servers 40, 42, 44, and 46, rating engine 48, DMZ 50, and mainframe 52 connected over a LAN 54.

The system for an embodiment of the present invention provides an online auto quoting facility that provides a user with a real-time auto insurance quote. The user can initiate contact with a personal lines CSR to purchase insurance based on that quote. The system connects to the rating server 48, such as a proprietary rating engine available from Agency Management System, Inc., prefills data into a host application and stores data to be retrieved via a computer telephony integration (CTI) system. The system application is written with Cold Fusion, Java, C, C++, Hypertext Markup Language (HTML), and JavaScript. An aspect of the system and method for an embodiment of the present invention is providing the online quoting facility on affinity client websites. The system enables the user to enter data into web pages constructed with Cold Fusion Markup Language (CFML), HTML, and minimal JavaScript.

Once the user information is entered, the user has, for example, three different levels of assistance for selecting coverages. One such level is a coverage wizard, which can utilize financial data, entered by the user and held only during the session, to make coverage recommendations. The user is allowed to use the coverage wizard to understand coverages without entering financial information. The user can also choose to have no assistance and enter coverages without guidance. When the user requests an online quote, a quote is presented to the user based upon the information entered. The user can change information at any time and request an updated quote. If the user likes the quote, he or she can contact a CSR. The CSR has the ability to retrieve the data in the host application when the call is connected. The system enables, for example, graphical data entry via the Internet. The coverage wizard suggests coverages based on user input. Information entered through the graphical interface is uploaded to the host system via IBM Message Queue (MQ).

In the past, an auto underwriter has used a web site as a vehicle for getting quote requests for its insurance products via email, which generates a fair amount of sold business for the underwriter. The system for an embodiment of the present invention goes beyond that process by presenting the user with an online quote. The generation of the quote online frees up CSR personnel to concentrate on the sale of policies, thus reducing costs. The upload of information collected by the system also reduces costs by eliminating the need for CSR personnel to retype the information into the host application for use in downstream systems. In addition, the data is uploaded to relational database system software, such as a Solaris Oracle database, to be used for management information systems (MIS) reporting.

The intended audience for the system of an embodiment of the present invention is the general public. In an aspect of the present invention, the audience for the includes various affinity groups. Advertising campaigns, such as advertising on search engine portals and Internet Service Providers (ISPs), is another aspect of the system of the present invention, which can significantly increase the number of quotes requested. Features of the system include, for example, a web-based deliverable over the Internet; a coverage wizard to facilitate the quoting process by calculating recommended coverage based on the information supplied by the user; a fast path quoting facility for those who know what coverages they need, application scalability to ensure availability to a large volume of concurrent users; integration with the host application, CTI and the auto insurer's downstream systems; real-time access to a vehicle identification number (VIN) database; real-time access to the rating engine 48 residing on the underwriter's DMZ 50; and retention of pertinent information in database format for use in MIS reporting.

The system for an embodiment of the present invention utilizes, for example, a web-based application, which has three major components, including a front end which is referred to as the presentation layer. The presentation layer is developed using, for example, Cold Fusion, and runs on a web application server 24. The web application server 24 communicates with the rating engine server 48 that provides comparative rates. Thus, the system makes use of the rating engine server 48 with a knowledge based system for underwriting owned by the underwriter, and from there it feeds data into the underwriter's CTI system, as well as back into the underwriter's host based system for issuance. The system is available on the Internet and is accessed, for example, via an auto insurer's web site and advertising click-through from external sites. The site accommodates a number of browsers and versions of those browsers, such as Internet Explorer 3.0.2 or greater, Netscape Communicator 3.x or greater, and all AOL browsers 3.x or greater.

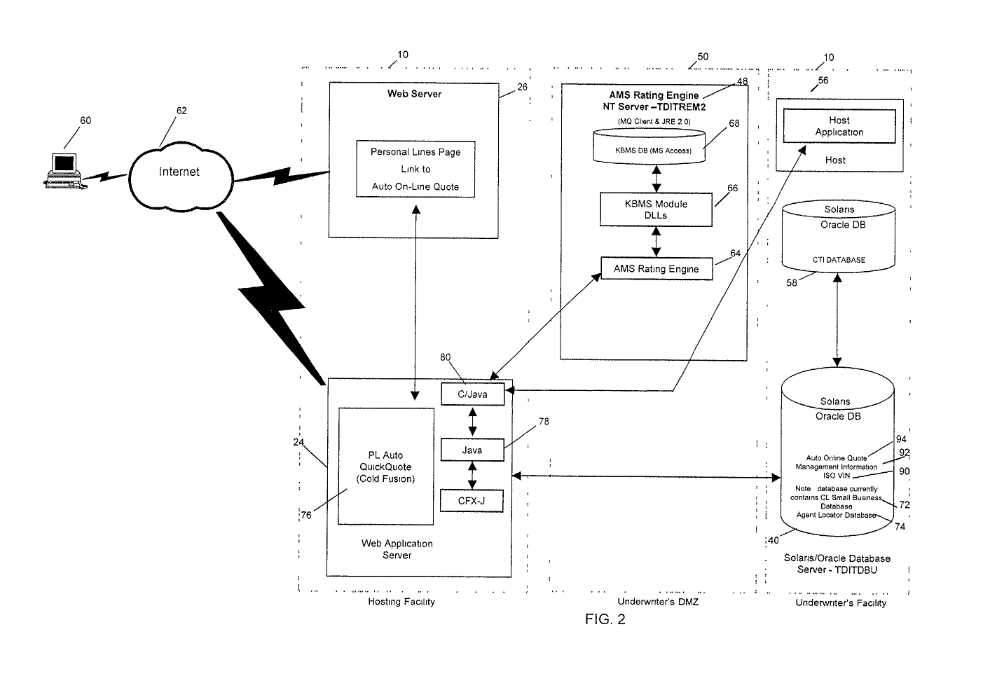

FIG. 2 is a schematic diagram which provides further detail regarding key components and the flow of information between key components of the system for an embodiment of the present invention shown in FIG. 1. Referring to FIG. 2, the hosting facility 10 includes, for example, the web server 26 and web application server 24; the underwriter's DMZ 50 includes, for example, the rating engine server 48; and the underwriter's facility 30 includes, for example, a host application 56 and database server 40. The system application consists of a web application development tool, such as web application server 24, a rating engine server 48, an Oracle management information (MI) database 92, a data feed to the host application 56 with Message Queue Interface (MQ), and a pull to a CTI database 58 from the system database 40. The web application server 24 maintains state with Cold Fusion session variables and presents Cold Fusion Markup Language (CFML) pages to users 60 over the Internet 62.

The rating engine 64, a Knowledge-Based Management System (KBMS) module 66, and the KBMS database 68 reside on rating engine server 48. MQ client and process 80 to forward data to the host application 56 reside on the application server 24. The Oracle database 40 contains the system database. A small business database 72, agent locator 74, and boat/yacht rating databases are also on the database server 40. The rating engine server 48 communicates through a socket connection on a pre-defined port number. The communication between the front-end 10 of the system and the rating engine server 48 is implemented in Java. Remote Method Invocation (RMI) is a model of distributed object application and has a RMI server 80 and RMI client 78. A typical server application creates some remote objects, makes references to them accessible, and waits for clients to invoke methods on these remote objects. A typical client application gets a remote reference to one or more remote objects in the server and then invokes methods on them. RMI provides the mechanism by which the server 80 and the client 78 communicate and pass information back and forth.

In the application for an embodiment of the present invention, once the Cold Fusion application 76 gets all of the input information from the user 60, it passes the information as a string object through the RMI server 80 in the web application server 24. The RMI server 80 then activates a C Dynamic Link Library (DLL) through Java Native Interface (JNI). The message is then passed to the MQSeries queue. The host application 56 picks up the application message from the queue and formats the user information in a CSR screen for quick and accurate service. This web server-to-mainframe host application message exchange makes use of a three tier distributed model. This not only makes the message exchange scalable and secure, it can also be reused in other similar application message exchanges with little or no modifications. The RMI server 80 on the middle tier server 50 uses a Java security policy file to limit the RMI server's access on the server, sometimes referred to as a “sandbox”. Besides using the three-tiered architecture for application message passing, the security feature is restricted by the Java2 platform. The RMI client 78 is digitally signed in order to communicate with the RMI server 80. This eliminates the risk of unauthenticated access to the RMI server 80 in the web application server 24.

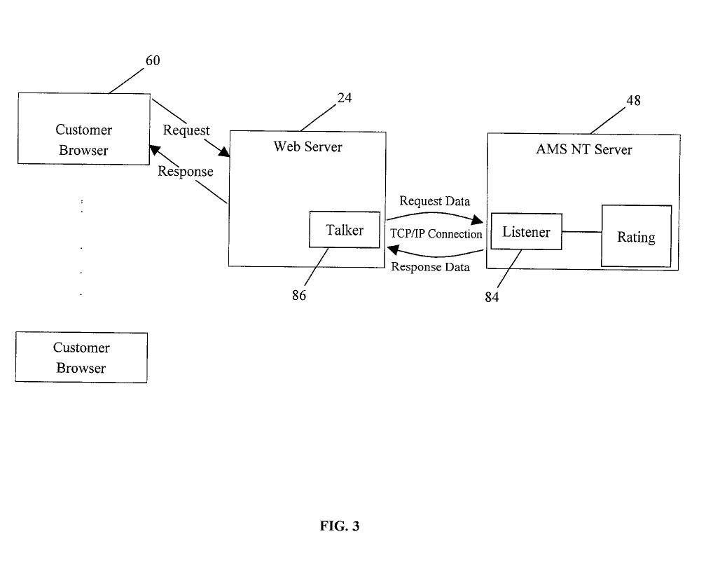

The rating engine 64 utilized for the system of the present invention is, for example, a proprietary rating engine developed by Agency Management System, Inc. and Lexitech. The KBMS module 66 is a proprietary knowledge-based management system developed by Lexitech. FIG. 3 is a schematic diagram which illustrates an overview of key components and the flow of information between key components for an example of the rating engine utilized for the system for an embodiment of the present invention. The rating engine server 48 provides a rating system which allows a front-end provider to utilize Applicative Real-Time Programming (ART) rating to calculate premiums. Input for the rating engine server 48 comes from the web application server 24. Communication between the rating engine server 48 and the web application server 24 is via a Transaction Control Protocol/Internet Protocol (TCP/IP) direct connection. The Data Transfer Protocol (DTP) defines the format that the front-end provider must use to submit data to the rating engine server 48. The DTP is a proprietary communication protocol supported by Agency Management System, Inc. The architecture/operating system for the rating engine 48, for example, is a 32-bit application under NT 4.0 server (with Service Pack 6A) with TCP/IP as the networking protocols. Hardware configuration requirements include, for example, 48 Megs RAM memory, more than 1 GB hard disk with at least 500 MB free disk space, and two Pentium II Pro Processors, 300 mhz CPUs. The development language used is Visual C++. With regard to data transfer, input or request data is packed in the DTP data buffer and sent into the rating system through the network. The output or response data has the same format.

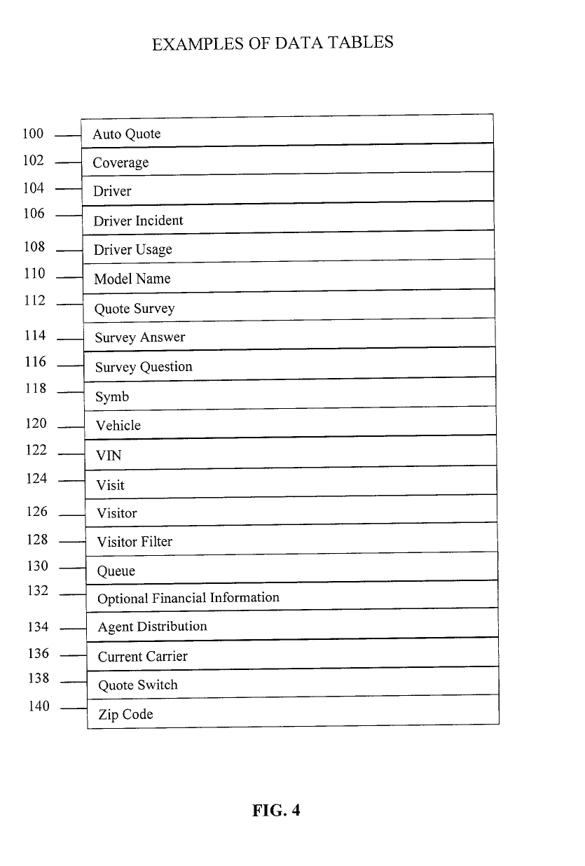

The system for an embodiment of the present invention stores data in the Oracle database 40 with Oracle database attributes. Data is passed, for example, to and from the rating engine server 48. Data is also sent to the host application 56. FIG. 4 is a chart which illustrates examples of data tables for the system of an embodiment of the present invention. Data tables include, for example, an Auto Quote table 100, a Coverage table 102, a Driver table 104, a Driver Incident table 106, a Driver Vehicle Usage table 108, a Model Name table 110, a Quote Survey table 112, a Survey Answer table 114, a Survey Question table 116, a Symb table 118, a Vehicle table 120, a VIN table 122, a Visit table 124, a Visitor table 126, a Visitor Filter table 128, a Queue table 130, various optional financial information tables 132, an Agent Distribution table 134, a Current Carrier table 136, a Quote Switch table 138, and a Zip Code table 140.

Retrieval and/or updating of data between the web application server 24 and the Oracle database server 40 is secured with application level user ID/passwords. Data transmission between the middleware RMI server 80 and the mainframe host application 56 are secured via MQ security. All communication paths are also secured via stateful inspection of conversations by at least two firewall layers. Confidential data is transferred between the web application server 24, the rating engine server 48, and the host 56. For communication between the web application server 24 and the user 60, Secure Sockets Layer (SSL) is used. A copy of the VIN data is available on the Oracle database 40 for VIN lookups. Consumer data is stored in the Oracle database 40. Consumer information is forwarded and stored on the host 56 in the host application and CTI 58 for CSR retrieval. Deployable content profile is stored in the Oracle database 40. Shadow password files are used to authenticate users 60 for a deployable content administration tool.

Referring further to FIG. 3, the DTP is a communication protocol for a network services “listener” 84 supported by Agency Management System, Inc. In one aspect, the listener 84 rates and/or edits a policy image. The DTP can accept multiple sets of data from different data models with the same set of actions performed on each for several companies. In operation, the listener 84 accepts a TCP/IP socket stream of data from the client program 86. The listener 84 executes the requested action on the image and replies to the client 86 with another stream on the same socket connection. The communication ends when the listener 84 closes the socket. Each stream of data is made up of components in a predetermined order. A DTP request stream is made up of several components, always beginning with listener and instruction blocks. Following these blocks, there may be multiple data sets with multiple table blocks in each. The instructions are carried out upon each data set.

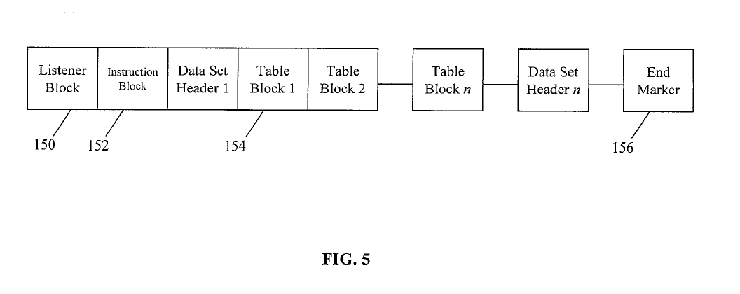

FIG. 5 is a block diagram which illustrates an example of a data transfer protocol visual model utilized for the system for an embodiment of the present invention. Referring to FIG. 5, a listener block 150 identifies the requester and its communications protocol. An instruction block 152 comprises information that is used for all the other components in the stream and is specific to DTP. A table block 154 identifies the table, gives the record count and lists the records along with their length, which is potentially variable. With regard to the tables end marker 156, in order to signify the last table in the data set is complete, a table ID that is equal to zero is sent. For the data set end marker, in order to signify the last data set is complete, a data format ID that is equal to zero is sent. Returned data is in the same format as the request data, with the listener and instruction blocks 150, 152 first. A new data set is returned for each combination of group, data retrieval action and original data set. All the data sets for a company are contiguous. All of the request data sets are also together.

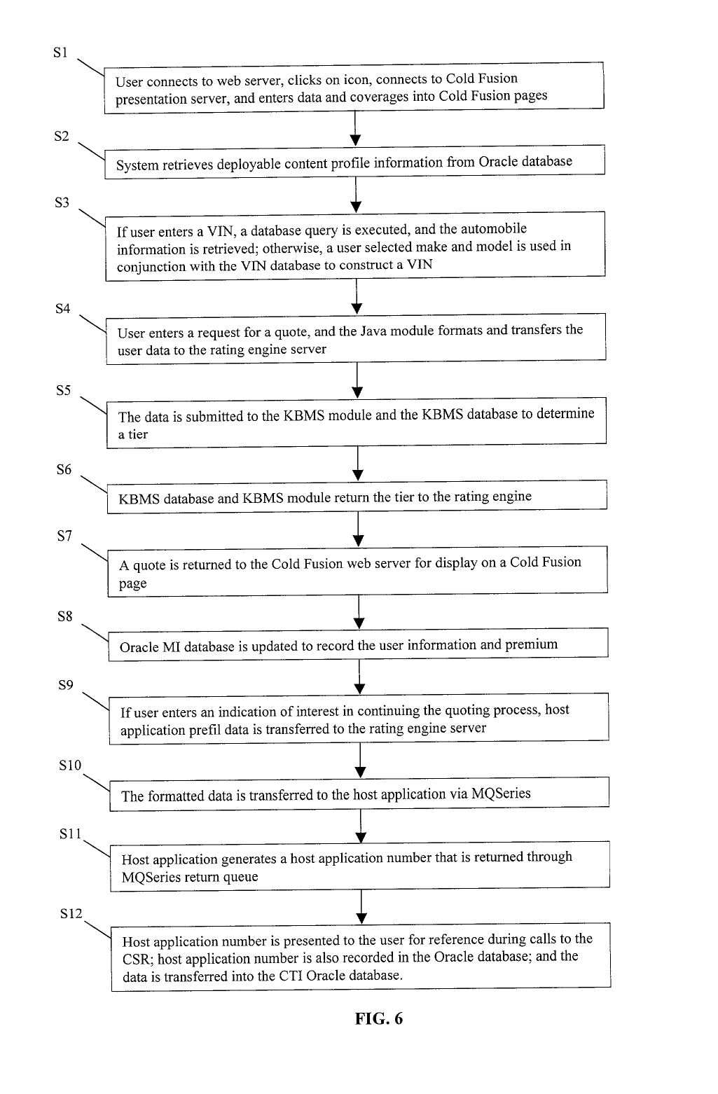

FIG. 6 is a flow chart which illustrates an example of the process of generating a quote by the system for an embodiment of the present invention. Referring to FIG. 6, at S1, the user 60 connects to the web server 26, clicks on an icon, connects to the web application server 24, and enters data and coverages into the Cold Fusion pages. At S2, the system retrieves deployable content profile information from the Oracle database 40. At S3, if the user 60 enters a VIN, a database query is executed, and the automobile information is retrieved; otherwise a user selected make and model is used in conjunction with the VIN database 90 to construct a VIN. At S4, the user 60 enters a request for a quote, and the Java module 78 formats and transfers the user data to the rating engine server 48.

Referring further to FIG. 6, at S5, the data is submitted to the KBMS module 66 and the KBMS database 68 to determine a tier. At S6, the KBMS database 68 and KBMS module 66 return the tier to the rating engine 64. At S7, a quote is returned to the web application server 24 for display on a Cold Fusion page. At S8, the Oracle MI database 92 is updated to record the user information and premium. At S9, if the user 60 is interested in continuing the quoting process, the host application prefil data is transferred to the rating engine server 48. At S 10, the formatted data is transferred to the host application 56 via MQSeries. At S11, the host application 56 generates a host application number that is returned through a MQSeries return queue. At S 12, the host application number is presented to the user 60 for reference during calls to the CSR. The host application number is also recorded in the Oracle database 40. The data is transferred into the CTI Oracle database 58.

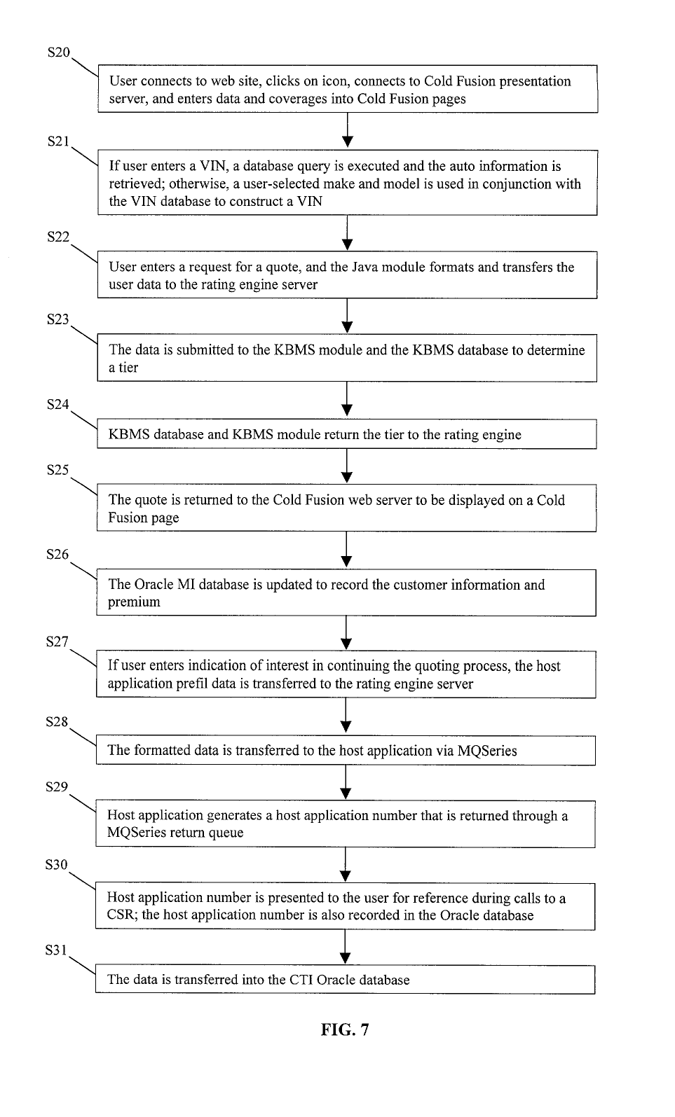

FIG. 7 is a flow chart which illustrates another example of the process of generating a quote by the system for an embodiment of the present invention. Referring to FIG. 7, at S20, the user 60 connects to the web site 26, clicks on an icon, connects to the web application server 24, and enters data and coverages into Cold Fusion pages. At S21, if the user 60 enters a VIN, a database query is executed and the auto information is retrieved. Otherwise, a user-selected make and model is used in conjunction with the VIN database to construct a VIN. At S22, the user 60 enters a request for a quote, and the Java module 78 formats and transfers the user data to the rating engine server 48. At S23, the data is submitted to the KBMS module 66 and the KBMS database 68 to determine a tier. At S24, the KBMS database 68 and KBMS module 66 return the tier to the rating engine 64.

Referring again to FIG. 7, at S25, the quote is returned to the web application server 24 to be displayed on a Cold Fusion page. At S26, the Oracle MI database 92 is updated to record the customer information and premium. At S27, if the user 60 is interested in continuing the quoting process, the host application prefil data is transferred to the rating engine server 48. At S28, the formatted data is transferred to the host application 56 via MQSeries. At S29, the host application 56 generates a host application number that is returned through a MQSeries return queue. At S30, the host application number is presented to the user 60 for reference during calls to a CSR. The host application number is also recorded in the Oracle database 40. At S3 1, the data is transferred into the CTI Oracle database 58.

In the on-line quote process for an embodiment of the present invention, the rates that are used, for example, are an underwriter's filed rates that are publicly available. However, instead of using the underwriter's rating engines that are back on the underwriter's host, an embodiment of the present invention makes use of a server based rating engine 64. In other words, the underwriter copies its underwriting rules and moves them to live on the server 48 that houses the rating engine 64 for its underwriting. Other aspects for an embodiment of the present invention include, for example, on-line purchasing and on-line issuance of insurance products, such as auto insurance.

Another aspect of the method and system for an embodiment of the present invention includes co-branding the application for use, for example, with the underwriter's affinity partners. Deployable content allows the underwriter to understand who comes in to use the application and to identify the users. The co-branding aspect of the present invention involves actually co-branding the web site with the underwriter's logo. The co-branding aspect provides the ability to customize presentation layer marketing and to customize content to affinity groups. In addition, the deployable content aspect allows the system to direct users through to either CSRs, which are located in the underwriter's service center, or to selected agents.

The web site can be customized to work with either the underwriter's existing CSRs or through specified agents, through deployable content, because the system has profiles for each of the affinity accounts. A user may be sent to an agent, as opposed to a CSR, because agents typically have a higher close rate than CSRs. Further, the system can target down to a particular zip code level to which a quote goes and who will process and close the quote and issue a policy. An advantage of that feature is that certain agents are Internet capable and understand how to close an internet deal, while others are not. In the latter case, the system can route the leads directly to the underwriter's service center.

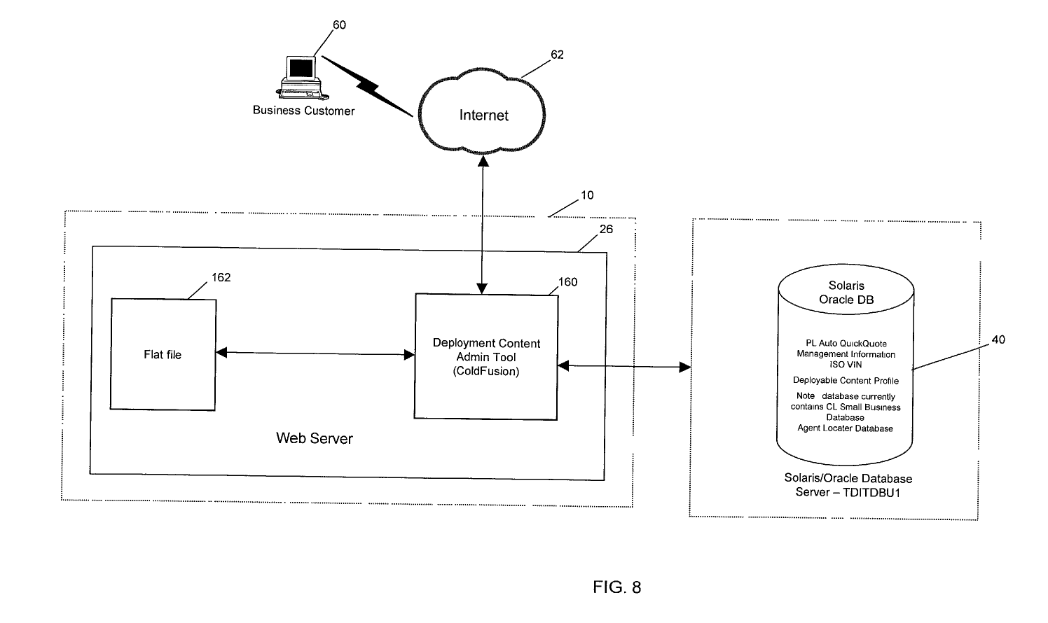

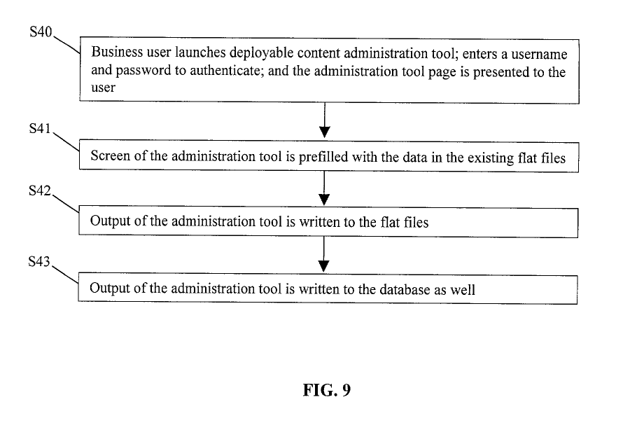

FIG. 8 is a schematic diagram that illustrates an example of components of the deployable content functionality for an embodiment of the present invention. The system integrates functionality of deployable content, banner ads, and support for affinity groups. In addition, the system of the present invention implements functionality, such as saving and retrieving profile information from the database. The profile information is written to both database and flat files. FIG. 9 is a flow chart which illustrates an example of the process flow of the deployable content administration tool application for an embodiment of the present invention. Referring to FIGS. 8 and 9, at S40, a business user 61 launches the deployable content administration tool 160. The business user 61 enters a username and password to authenticate, and the administration tool page is presented to business user 61. At S41, the screen of the administration tool 160 is pre-filled with the data in the existing flat files 162. At S42, the output of the administration tool 160 is written to the flat files 162. At S43, the output of the administration tool 160 is written to the database 40 as well. Authentication solutions for the deployable content administration tool 160 include, for example, the use of shadow passwords and secure token IDs. A shadow password is a “hidden” file that stores all user passwords and can be read only by root. It is a Unix method for controlling the creation, use, and safe storage of passwords that involves the use of shadow password files and is administered from the Unix infrastructure. The use of secure token IDs entails the creation of infrastructure to use smart cards.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for furnishing a real-time on-line quote for an insurance product for a user, comprising:
allowing the user to enter user data and coverage information on a presentation server;
retrieving deployable content profile information for the user from a database by the presentation server;
if a vehicle identification number is entered by the user, retrieving auto information corresponding to the vehicle identification number for the user from a vehicle identification database by the presentation server;
otherwise, constructing a vehicle identification number for the user by the presentation server utilizing user-entered make and model information in conjunction with the vehicle identification number database;
allowing the user to enter a request for the quote on the presentation server;
displaying the requested quote for the user by the presentation server; and
if an indication of continued interest in the requested quote is received from the user by the presentation server, presenting a client number associated with the quote for the user and sending quote data for the user to a computer telephony integration database.

2. The method of claim 1, wherein allowing the user to enter the user data and coverage information further comprises allowing the user to log on to a web site and access an on-line quote application on the presentation server via a link from the web site.

3. The method of claim 1, wherein retrieving the deployable content profile information for the user further comprises retrieving deployable content allowing the user to be identified by an underwriter.

4. The method of claim 1, wherein retrieving the deployable content profile information for the user further comprises retrieving deployable content allowing the user to be directed to one of a customer support representative and a selected agent.

5. The method of claim 1, wherein retrieving the deployable content profile information for the user further comprises allowing a business user to access a deployable content administration tool page.

6. The method of claim 5, wherein allowing the business user to access the deployable content administration tool page further comprises authenticating the business user with a username and password.

7. The method of claim 5, wherein allowing the business user to access the deployable content administration tool page further comprises presenting an administration tool screen for the business user pre-filled with data from existing files.

8. The method of claim 5, wherein allowing the business user to access the deployable content administration tool page further comprises writing an administration tool output to a file.

9. The method of claim 5, wherein allowing the business user to access the deployable content administration tool page further comprises writing an administration tool output to the database.

10. The method of claim 1, wherein retrieving the auto information corresponding to the vehicle identification number for the user further comprises executing a database query by the presentation server.

11. The method of claim 1, wherein allowing the user to enter the request for the quote further comprises formatting and transferring the user data to a rating engine server.

12. The method of claim 11, wherein formatting and transferring the user data to the rating engine server further comprises formatting and transferring the user data to the rating engine server via a Java module.

13. The method of claim 12, wherein formatting and transferring the user data to the rating engine server further comprises submitting the user data to a knowledge-based management system module and database.

14. The method of claim 13, wherein formatting and transferring the user data to the rating engine server further comprises determining a tier corresponding to the user data by the knowledge-based management system module and database.

15. The method of claim 14, wherein formatting and transferring the user data to the rating engine server further comprises returning the tier to the rating engine server by the knowledge-based management system module and database.

16. The method of claim 1, wherein displaying the requested quote for the user further comprises updating a management information database with the user data and quote.

17. The method of claim 1, wherein presenting the client number further comprises transferring pre-fill data for the user to the rating engine server by the presentation server.

18. The method of claim 17, wherein presenting the client number further comprises transferring formatted user data to a host application via message queue series.

19. The method of claim 18, wherein presenting the client number further comprises generating the client number by the host application.

20. The method of claim 19, wherein presenting the client number further comprises returning the client number by the host application through a message queue series return queue.

21. The method of claim 20, wherein presenting the client number further comprises displaying the client number for the user by the presentation server for reference in communicating with a customer support representative.

22. The method of claim 21, wherein presenting the client number further comprises logging the client number in a management information database.

23. The method of claim 22, wherein presenting the client number further comprises recording the client number in a quote database.

24. A system for furnishing a real-time on-line quote for an insurance product for a user, comprising:
means for allowing the user to enter user data and coverage information on a presentation server;
means for retrieving deployable content profile information for the user from a database by the presentation server;
means for retrieving auto information corresponding to the vehicle identification number for the user from a vehicle identification database by the presentation server, if a vehicle identification number is entered by the user;
means for constructing a vehicle identification number for the user by the presentation server utilizing user-entered make and model information in conjunction with the vehicle identification number database, if the user fails to enter a vehicle identification number;
means for allowing the user to enter a request for the quote on the presentation server;
means for displaying the requested quote for the user by the presentation server; and
means for presenting a client number associated with the quote for the user and sending the quote data for the user to a computer telephony integration database, if the indication of continued interest in the requested quote is received from the user by the presentation server.

25. The system of claim 24, wherein the means for allowing the user to enter the user data and coverage information further comprises means for allowing the user to log on to a web site and access an on-line quote application on the presentation server via a link from the web site.

26. The system of claim 24, wherein the means for retrieving the deployable content profile information for the user further comprises means for retrieving deployable content allowing the user to be identified by an underwriter.

27. The system of claim 24, wherein the means for retrieving the deployable content profile information for the user further comprises means for retrieving deployable content allowing the user to be directed to one of a customer support representative and a selected agent.

28. The system of claim 24, wherein the means for retrieving the deployable content profile information for the user further comprises means for allowing a business user to access a deployable content administration tool page.

29. The system of claim 28, wherein the means for allowing the business user to access the deployable content administration tool page further comprises means for authenticating the business user with a username and password.

30. The system of claim 28, wherein the means for allowing the business user to access the deployable content administration tool page further comprises means for presenting an administration tool screen for the business user pre-filled with data from existing files.

31. The system of claim 28, wherein the means for allowing the business user to access the deployable content administration tool page further comprises means for writing an administration tool output to a file.

32. The system of claim 28, wherein the means for allowing the business user to access the deployable content administration tool page further comprises means for writing an administration tool output to the database.

33. The system of claim 24, wherein the means for retrieving the auto information corresponding to the vehicle identification number for the user further comprises means for executing a database query by the presentation server.

34. The system of claim 24, wherein the means for allowing the user to enter the request for the quote further comprises means for formatting and transferring the user data to a rating engine server.

35. The system of claim 24, wherein the means for formatting and transferring the user data to the rating engine server further comprises means for formatting and transferring the user data to the rating engine server via a Java module.

36. The system of claim 35, wherein the means for formatting and transferring the user data to the rating engine server further comprises means for submitting the user data to a knowledge-based management system module and database.

37. The system of claim 36, wherein the means for formatting and transferring the user data to the rating engine server further comprises means for determining a tier corresponding to the user data by the knowledge-based management system module and database.

38. The system of claim 37, wherein the means for formatting and transferring the user data to the rating engine server further comprises means for returning the tier to the rating engine server by the knowledge-based management system module and database.

39. The system of claim 24, wherein the means for displaying the requested quote for the user further comprises means for updating a management information database with the user data and quote.

40. The system of claim 24, wherein the means for presenting the client number further comprises means for transferring pre-fill data for the user to the rating engine server by the presentation server.

41. The system of claim 40, wherein the means for presenting the client number further comprises means for transferring formatted user data to a host application via message queue series.

42. The system of claim 41, wherein the means for presenting the client number further comprises means for generating the client number by the host application.

43. The system of claim 42, wherein the means for presenting the client number further comprises means for returning the client number by the host application through a message queue series return queue.

44. The system of claim 43, wherein the means for presenting the client number further comprises means for displaying the client number for the user by the presentation server for reference in communicating with a customer support representative.

45. The system of claim 44, wherein the means for presenting the client number further comprises means for logging the client number in a management information database.

46. The system of claim 45, wherein the means for presenting the client number further comprises means for recording the client number in a quote database.
